(19) United States
(12) Patent Application Publication
(10) Pub. No.: US 2015/0160968 A1
(43) Pub. Date: Jun. 11, 2015

(54) FREEZING A CALL STACK

(71) Applicant: MetraTech Corp., Waltham, MA (US)

(72) Inventor: Jonah Egenolf, Winchester, MA (US)

(21) Appl. No.: 14/102,714

(22) Filed: Dec. 11, 2013

(51) Int. Cl. G06F 9/48

(52) U.S. Cl. CPC G06F 9/4812

(57) ABSTRACT

Methods, systems, and apparatus, including computer programs encoded on computer storage media, for suspending a call stack. One of the methods includes executing a first task on the data processing apparatus. The method includes identifying a first command to be executed by the first task, the first command being associated with commands to be executed as a group. The method includes suspending the task by freezing a call stack associated with the first task, in response to the first command. The method includes associating the task with a set of previously suspended tasks based on the first command. The method includes while the first task is suspended processing a second task on the data processing apparatus.

### BACKGROUND

This specification relates to computer operations.

A call stack is a data structure that stores information about the active subroutines of a computer program. A call stack is used to keep track of the point to which each active subroutine should return control when it finishes executing. An active subroutine is one that has been called but is yet to complete execution after which control should be handed back to the point of call. A call stack can store the address to which control should return when a subroutine completes as well as values of parameters that are passed into the subroutine.

### SUMMARY

This specification describes technologies relating to task management.

In general, one innovative aspect of the subject matter described in this specification can be embodied in methods that include the actions of executing a first task on the data processing apparatus. The methods include the actions of identifying a first command to be executed by the first task, the first command being associated with commands to be executed as a group. The methods include the actions of in response to identifying the first command, suspending the task by freezing a call stack associated with the first task. The methods include the actions of associating the task with a set of previously suspended tasks based on the first command. The methods also include the actions of while the first task is suspended processing a second task on the data processing apparatus.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. Identifying the first command may include comparing an operator of the first command to a predefined list of operators. The methods may include in response to determining a condition has occurred, continue executing each of the tasks in the set of previously suspended tasks. Determining that the condition has occurred may include comparing a count of the tasks in the set of previously suspended tasks to a threshold value. Determining that the condition has occurred may be based on a time associated with at least one task in the set of previously suspended tasks and the current time. Freezing the call stack may include moving the call stack from a first memory to a second memory.

Particular embodiments of the subject matter described in this specification can be implemented so as to realize one or more of the following advantages. The performance of a computer system may be improved. The computer system may more efficiently utilize computing resources. Operations may be grouped to improve performance while maintaining the appearance of real time or near real time processing.

In one example fixed cost is quantified as time, but it could just as easily be a dollar fixed cost. Perhaps a data processor charges per request and allows up to N transactions in a single request. There could be cost savings associated with freezing when the latency cost is acceptable. Fixed performance costs associated with some activities may be amortized multiple transactions such that the fixed cost allocated to each transaction may be reduced.

Asynchronous executions may be made without losing the appearance of synchronous processing. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates processing tasks.

FIG. 2 is a flow chart of an example process processing tasks.

FIG. 3 is a block diagram illustrating suspending a task.

FIG. 4 is a diagram showing an exemplary implementation of a call stack.

FIG. 5 is diagram showing a table representing an example of memory addresses and values associated with a call stack.

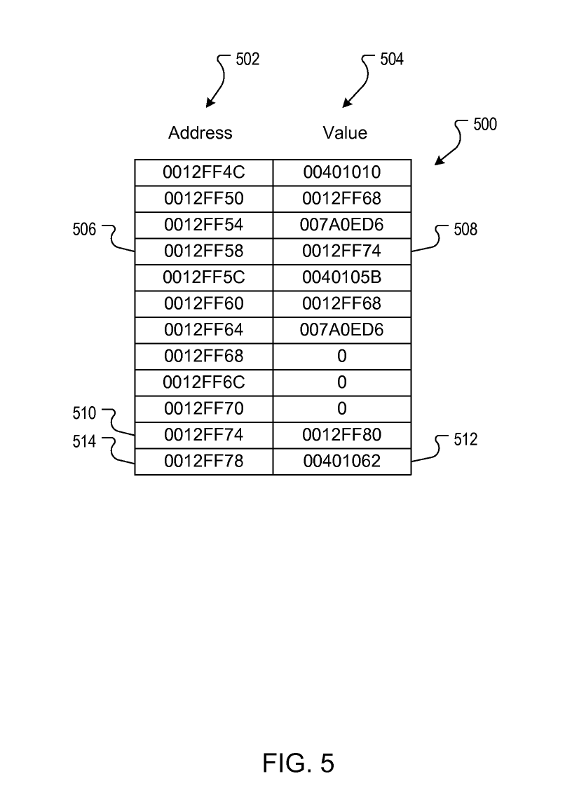

FIG. 6 is a flow chart an example process for improving system performance through call stack freezing.

Like reference numbers and designations in the various drawings indicate like elements.

### DETAILED DESCRIPTION

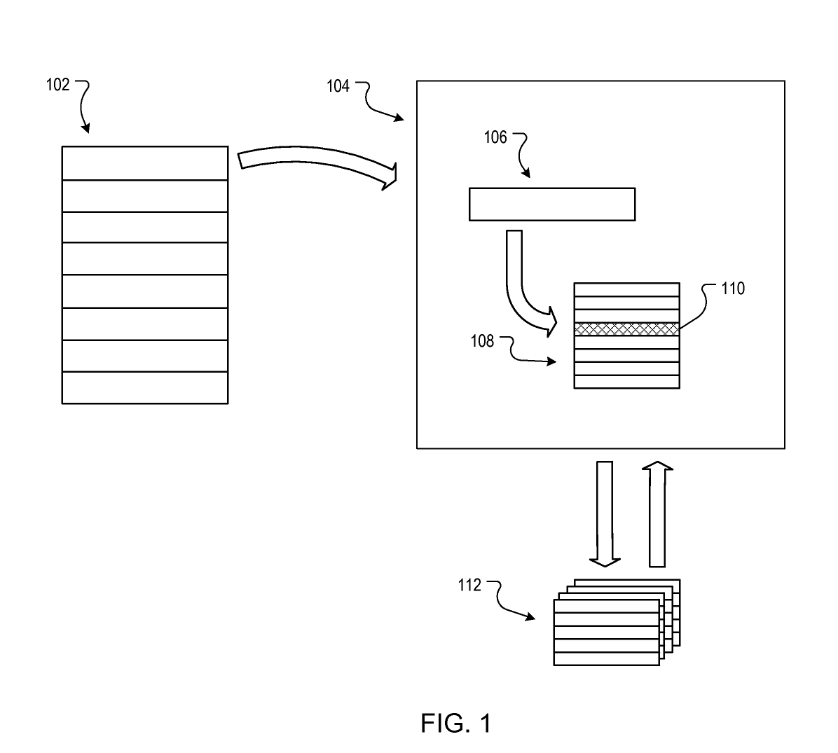

FIG. 1 is a block diagram that illustrates processing tasks. A queue 102 can store a series of tasks to be performed by a data processor 104. The data processor 104 takes a task 106 from the queue 102. The task 106 can be broken into a series of operations 108, each operation can be performed individually be the data processor 104.

Some of the operations, for example operation 110, can have better performance characteristics if they are performed in a batch. For example, performing a database select can require establishing a connection to a database, performing the select statement, reading the results, and closing the connection to the database. However, if there are multiple database select statements to be performed, then the performance of the system can be improved by executing the different select statements at the same time. In this example, the computer system may establish a connection to the database, perform the first select statement, read the results from the first select statement, perform the second select statement, read the results from the second select statement, and close the connection to the database. Here, the performance of the computer system is improved because only one database connection needs to be established and closed. Other operations may also be performed in batch.

When the data processor 204 identifies an operation that is better performed in batch the data processor 104 suspends the task and stores the operations in a data store 112. In some examples, the tasks are suspended by freezing the call stack as described herein. The tasks can be grouped based on the operation that caused the task to be suspended. For example, tasks that require access to a particular disk may be group together, tasks that require access to a particular database may be group together, etc. In some implementations, the operations that are better performed in batch are predetermined by a user of the data processing system. For example, the user may identify different types of operations that should be grouped together, such as database operations, input/output requests (10) etc.

Once some condition is reached, for example, a period of time has elapsed since the task was suspended or a predetermined number of tasks have been suspended, the data processor 104 can resume processing the tasks that have been stored in the data store 112. In some implementations, the data processor 104 performs operations so that the operations appear to be occurring in real-time or near-real time. A task processing in real time appears to be processing as the tasks are received without substantial delay. In some implementations, real-time processing requires that the tasks are performed within a predetermined period of time from when they are received. In order to conform to the requirements of real-time computing, the tasks may only be suspended for a period of time, in order to meet the time requirements for processing the entire task. In some implementations, different groups of suspended tasks may have different periods of time for which they may be suspended, depending on the group.

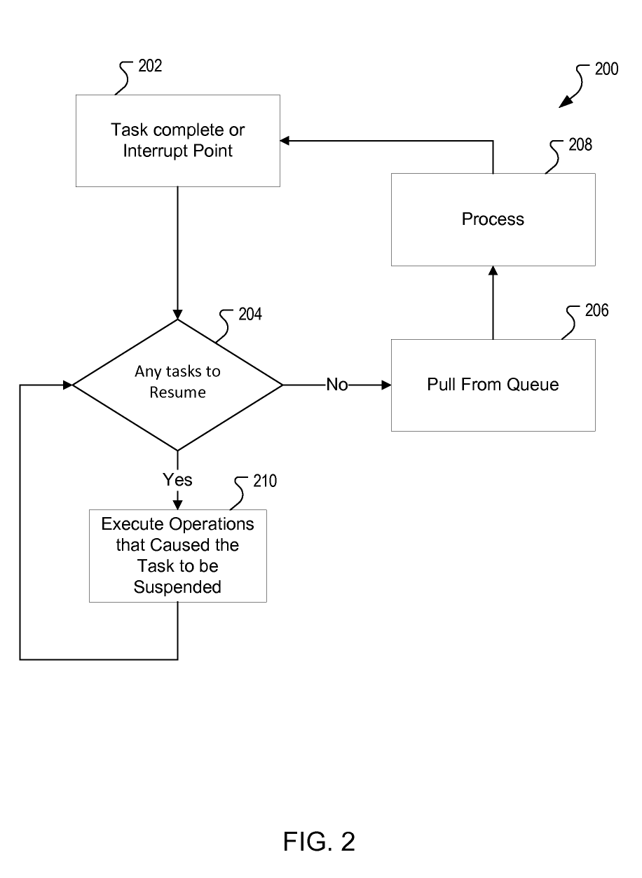

FIG. 2 is a flow chart of an example process 200 performing tasks. The process 200 may be performed by a data processor, such as a computer. For example, the process may be performed by the data processor 104 of FIG. 1.

When a task is completed or an interrupt point is reached (202), the process 200 determines if there is any tasks to resume 204 (e.g., any call stacks that have previously been frozen). An interrupt point can be any point in processing a task where the tasks may be suspended. For example, an interrupt point may occur after a transaction has completed, but not while a transaction is processing.

Determining if there is anything to resume (204) can include determining how many tasks were previously suspended. As discussed above, suspended tasks can be grouped with other suspended tasks based on the operation that caused them to be suspended. In some implementations, determining if there is anything to unfreeze can include determining how many suspended tasks are in each group and comparing them to a threshold.

Determining if there is any tasks to resume (204) can also include determining how long it has been since each tasks was suspended. In some implementations, a task is only suspended for up to a predetermined period of time.

If there are no tasks to resume, the process 200 pulls a new tasks from the queue 206, for example, the queue 102 of FIG. 1. The process 200 processes the task pulled off the queue until the task is complete or an interrupt point is reached (202). Thus, the process continues to process tasks from the queue while other tasks are suspended (e.g., continues to process additional tasks on a main call stack while other frozen call stacks are in a suspended state).

If there are tasks to resume, the process 200 performs the operations that caused the tasks to be suspended (210). In some implementations, the process 200 performs the operations that caused the tasks to be suspended for each task in the group.

During the process 200, additional tasks may be received by the queue for processing. In scenarios where the task is received while the operations that caused the task to be suspended are being performed, the task may wait in the queue. In some implementations, the newly received task may cause processing of the resumed tasks to be re-suspended based on a priority value associated with the task.

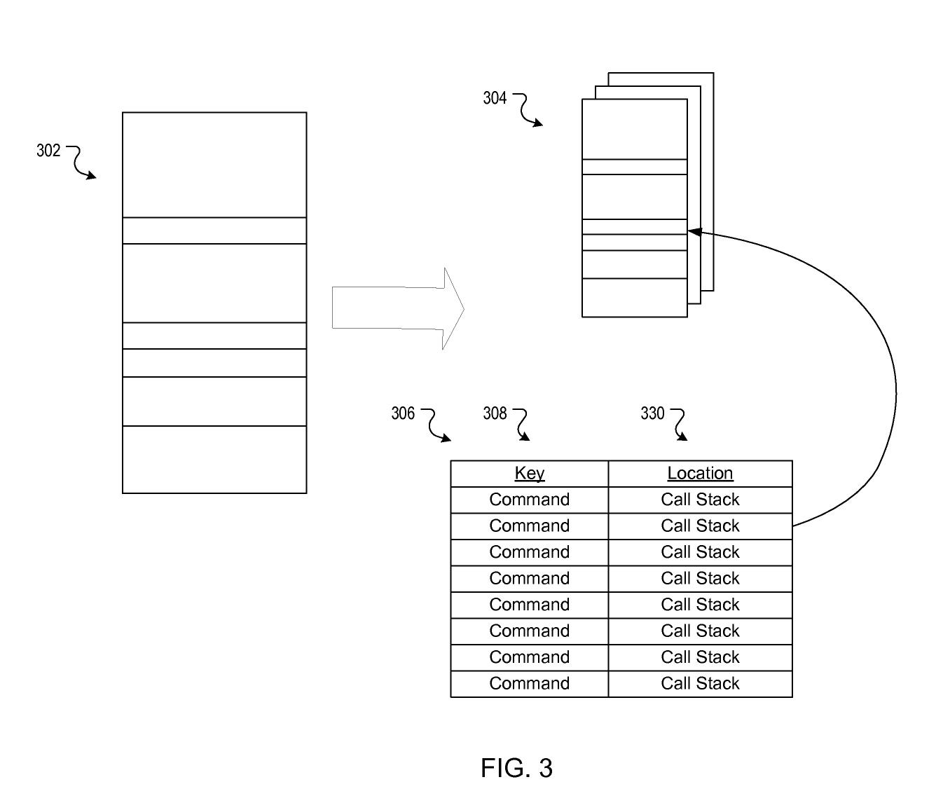

The process 200 described above can be adapted to function with a traditional computer call stack. As described above, tasks can be suspended and reinstated. As shown in FIG. 3, suspending a task can include freezing a call stack 302. In some implementations, a task may be suspended to attempt to improve the performance of the system. In this example, when the computer system detects a select operation the computer system suspends the process and stores the call stack 302 in an alternate data store 304. In some implementations, the data store may be stored in volatile memory or in persistent (non-volatile) memory. Volatile memory includes memory that requires power in order to maintain the stored information (e.g. random access memory (RAM), dynamic random access memory (DRAM) etc.). Persistent memory does not require power to maintain the stored information (e.g. magnetic tape, hard disks, flash memory, etc.) The computer system may maintain a table 306, or other similar data structure, which groups the call stacks by a key 308 and a location 310. The key 308 may indicate the operation or group of operations which can be used to organize the call stacks. For example, the key may indicate that the operation is going to perform a particular SQL SELECT statement on a table, or may indicate that the operation is going to before a SQL SELECT statement generally. The location 310 may identify where the call stack is stored in the data store, for example, by using a pointer.

In some implementations, the call stack is not stored in an alternative data store, but remains in memory as the execution of the call stack is suspended.

When a condition occurs, for example, when a predetermined number of call stacks associated with an operation or group of operations have been frozen or when a predetermined period of time has passed since the call stack was frozen, then the frozen call stack or call stacks are permitted to continue and complete the operations.

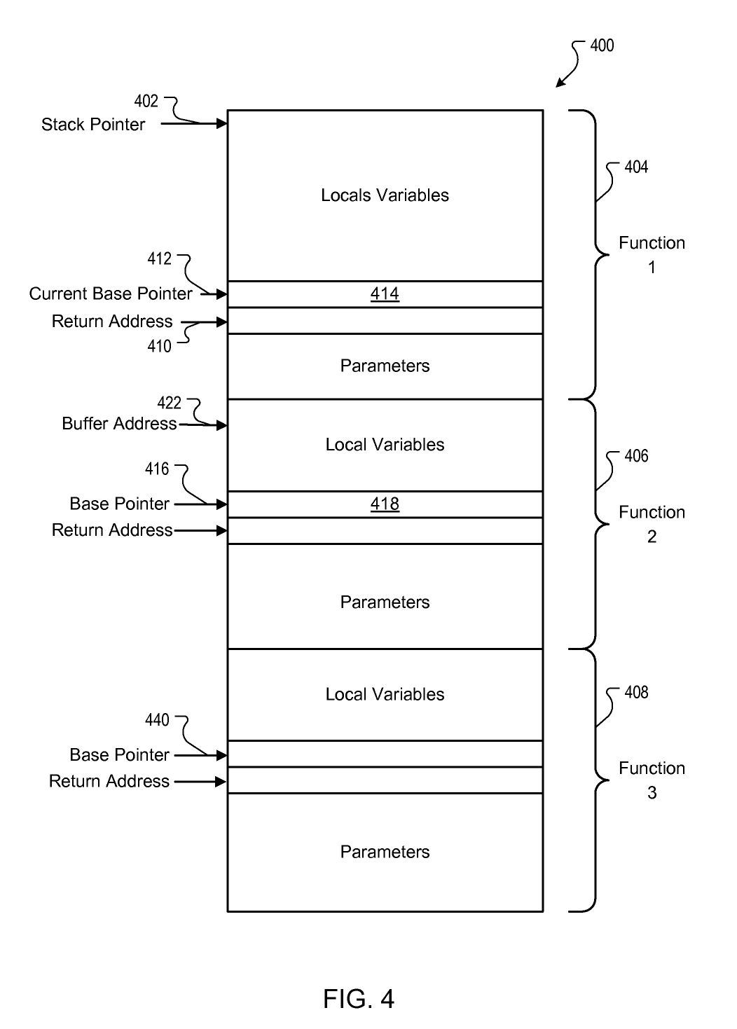

FIG. 4 is a diagram showing an exemplary implementation of a call stack. A call stack 400 is a data structure that stores information about executing subroutines of a computer program. As used herein an executing subroutine is a subroutine that has not been terminated and for which a return statement has not been executed.

A stack is a first in, last out data structure, which means that the last item “pushed” onto the stack, is the first item “popped” off the stack. A stack pointer 402 points to the current top of the stack, i.e., points to a memory address identifying a memory location in the stack.

The structure of stack frames vary from based on the hardware of the computer. In general, information about each executing subroutine is stored in a separate stack frame 404, 406, 408 in the call stack 400. For example, referring to FIG. 2, the subroutine “Function 3” is the furthest down the stack (stack frame 408), and was therefore called first. “Function 2” is the next on the stack (stack frame 406) and was therefore called second. “Function 1” is at the top of the stack (stack frame 404) and was called last. In a computer program with a single thread of execution, this indicates that “Function 3” called “Function 2”, which called “Function 1”.

Each stack frame contains information about the subroutine. For example, each stack frame contains a return address and a base pointer. The return address is the location to which the subroutine should return control when the subroutine terminates. The base pointer identifies the location of the return address. The base pointer of the currently active subroutine is referred to as the current base pointer. In some implementations of the call stack, the memory location identified by a base pointer identifies the base pointer of the calling subroutine and the return pointer is the following entry in the call stack. For example, the current base pointer 412 points to a memory location 414 which contains the address of the base pointer 416. In turn, the base pointer 416, identifies a memory location 418 which in turn contains the address of the next base pointer 420. In many embodiments, the return address is in the memory location immediately following the location identified by the base pointer.

The stack frame may also store parameters associated with the subroutine as well as local variables. For example, the call stack may include memory associated with a buffer 422.

Freezing a call stack can include copying data from the call stack into a new memory address. FIG. 3 is diagram showing a table representing an example of memory addresses and values associated with a call stack. The table 500 includes a memory address column 502 and a value column 504. The memory address column identifies the memory address of the memory location in which the value is stored. In this example, a base pointer 506 located at memory address 0012FF58 has a value 508 that identifies the memory address of the next base pointer 510, in this case the value ‘0012FF74”. The return address 512 for the next base pointer 510 is stored in the next available memory location 514. In this example, each memory location is four bytes long and therefore the return address is located at memory location “0012FF74”+4 or at memory address “0012FF78”.

When the call stack is frozen, the information in the call stack is copied to a new memory location. In some implementations, the call stack may be addressed relative to the base pointer, that is, each address in the call stack is determined based on an offset from the base point. In this implementation, the value of the base pointer may need to be updated from an old address to a new address, whereas the remaining values may remain the same.

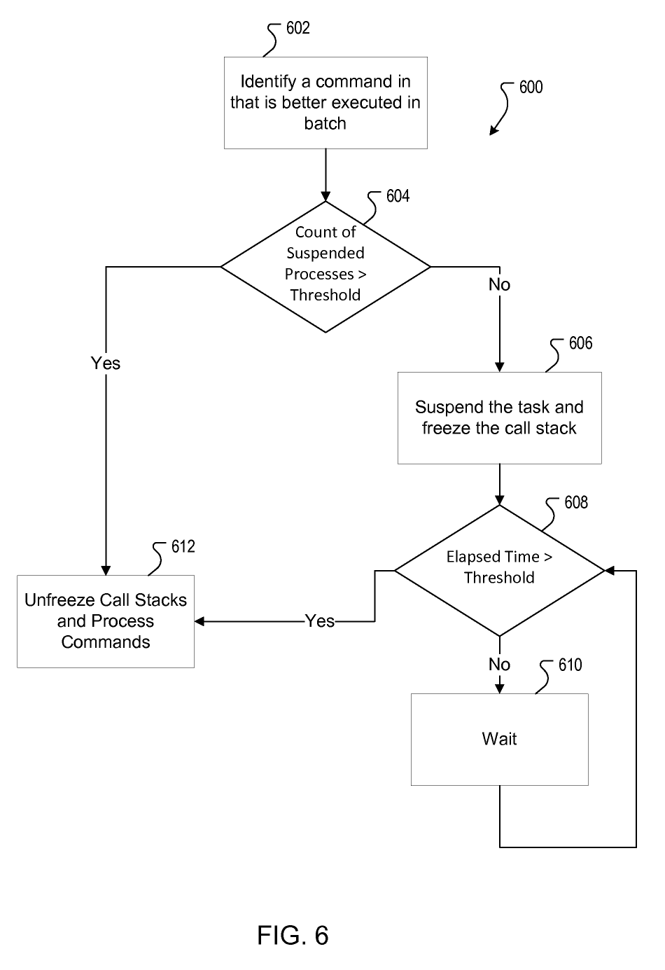

FIG. 6 illustrates an example process 600 for improving system performance through call stack freezing. The process may be performed by a computer system that has one or more processors and a memory for storing instructions. For simplicity, the process 600 will be described in relation to a system performing the process.

An operation that is to be performed in batch is identified (602). As discussed above, some computer operations can exhibit improved performance if performed in batch. For example, an operation may include overhead or other processing steps that can be reused or shared across multiple operations. For example, once a database connection is established, the connection may be used to perform multiple database operations. Other processing steps that may be shared across multiple operations include establishing a connection over a network, for example, establishing a connection with a remote computer, such as through a hyper transport protocol (HTTP) connection, writing data to a persistent queue, writing data to a file system, etc.

Another example of operations that can exhibit performance improvements includes context switches. For example, a database parses a query, plans the execution of the query and executes the query. In general, each query sent to the database for execution can require the database engine to determine which data should be mined and returned. Databases attempt to reduce costs associated with the mining as much as possible, but it's always more than zero. This performance cost associated with the parsing queries and planning query execution can be reduced by combining multiple distinct queries that are structurally identical into a single query and executing a single query rather than the multiple distinct queries separately. The results of the single query can be divided according to the multiple queries returned to the appropriate call stack.

Another example of operations that can exhibit performance improvements includes sending data over a network. In systems where network is bandwidth not constrained, network latency, generally, may not increase linearly with throughput. Overall network latency can be reduced by sending data in larger blocks if data and the latency attributed to each unit of data can be similarly reduced.

Call stack freezing can be used to make asynchronous executions without losing the appearance of synchronous processing. For example, an operation on an external system may be very slow, but the current machine is the resource bottleneck, sending even a single unit of work, freezing the call stack to move on to other work, and thawing the call stack when the execution is complete can result in large performance gains. In some arrangements, freezing the call stack can provide similar benefits to executing multiple threads where the thread simply has to wait for the response from the external system.

In some implementations, identifying the operation can include comparing an operator of the operation to a predetermined list of operations. For example, a predetermined list of operations may include a database select, a database update, a database delete, or a database insert.

Frozen call stacks may be grouped based on the operations that caused the call stack to be suspended. For example, each of the operations described above may be included in a database operations group. Call stacks that were frozen as a result of a database operation may be grouped (logically or physically) with other call stacks that were frozen as a result of database operations. In some implementations, the call stacks may be identified in a look up table, or through another similar data structure.

In some implementations, the command may be identified by comparing the call stack to a set of previously identified commands. The set of previously identified commands may identify commands that are preferably executed in a batch. Alternatively, the command may be altered so the process described herein is performed when the command is executed. For example, command to open a database connection may be altered to freeze the call stack.

Once a call stack is frozen, the time that the stack was frozen may be recorded and stored with the call stack. The recorded time may be compared to a current time to determine how long the call stack has been frozen.

A count of the number of frozen call stacks is compared to a threshold (604). If the count of frozen call stacks exceeds the threshold, then the process unfreezes all the call stacks in the group and allows commands to execute (612). I some implementations, the call stacks are executed in the order in which they were frozen. If the count of suspended processes does not exceed the threshold, then the process suspends the task and freezes the call stack (606) as described above. In some implementations, the process can allow the operations which resulted in freezing the call stack to execute sequentially so that each frozen call stack performs the processing prior to any call stack releasing the necessary resources.

The time since the call stack was frozen is compared to a threshold (608). In order to maintain the appearance that processes are being executed in real-time, any particular call stack cannot be suspended for a noticeable period of time. If the any call stack has been frozen greater than a threshold period of time then all of the frozen call stacks in the group are unfrozen and allowed to process, as described above (612). The threshold may be, for example, 200 ms, 500 ms, 1 s, 2 s, etc. In some implementations, the threshold can be based on resources available to store frozen call stacks.

If the call stack has not been frozen for greater than the threshold period of time then the process waits (610). Periodically, the period of time since the call stack was frozen is compared to the threshold again (608).

In some implementations, a separate timer process may check the frozen processes periodically. For example, the timer process may check the frozen call stacks every 200 ms. The timer process may monitor multiple groups of frozen call stacks. For example, the timer process may monitor a first group of call stacks that were frozen because of pending database operations and a second group of call stacks that were frozen due to network connectivity. In some implementations, only the oldest frozen call stack in each group is checked against the threshold.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on non-transitory computer readable medium for execution by, or to control the operation of, data processing apparatus. A computer readable medium can be, or be included in, a computer-readable storage device, a computer-readable storage substrate, a random or serial access memory array or device, or a combination of one or more of them. The computer readable medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
executing a first task on the data processing apparatus;
identifying a first command to be executed by the first task, the first command being associated with commands to be executed as a group;
in response to identifying the first command, suspending the task by freezing a call stack associated with the first task;
associating the task with a set of previously suspended tasks based on the first command; and
while the first task is suspended processing a second task on the data processing apparatus.

2. The method of claim 1, wherein identifying the first command includes comparing an operator of the first command to a predefined list of operators.

3. The method of claim 1, further comprising:
in response to determining a condition has occurred, continue executing each of the tasks in the set of previously suspended tasks.

4. The method of claim 3, wherein the determining that the condition has occurred includes comparing a count of the tasks in the set of previously suspended tasks to a threshold value.

5. The method of claim 3, wherein determining that the condition has occurred is based on a time associated with at least one task in the set of previously suspended tasks and the current time.

6. The method of claim 1, wherein freezing the call stack includes moving the call stack from a first memory to a second memory.

7. A system comprising:
one or more computers and one or more storage devices storing instructions that are operable, when executed by the one or more computers, to cause the one or more computers to perform operations comprising:
executing a first task on the data processing apparatus;
identifying a first command to be executed by the first task, the first command being associated with commands to be executed as a group;
in response to identifying the first command, suspending the task by freezing a call stack associated with the first task;
associating the task with a set of previously suspended tasks based on the first command; and
while the first task is suspended processing a second task on the data processing apparatus.

8. The system of claim 7, wherein identifying the first command includes comparing an operator of the first command to a predefined list of operators.

9. The system of claim 7, wherein the operations further comprise:
in response to determining a condition has occurred, continue executing each of the tasks in the set of previously suspended tasks.

10. The system of claim 9, wherein the determining that the condition has occurred includes comparing a count of the tasks in the set of previously suspended tasks to a threshold value.

11. The system of claim 9, wherein determining that the condition has occurred is based on a time associated with at least one task in the set of previously suspended tasks and the current time.

12. The system of claim 7, wherein freezing the call stack includes moving the call stack from a first memory to a second memory.

13. A computer storage medium encoded with computer program instructions that when executed by one or more computers cause the one or more computers to perform operations comprising:
executing a first task on the data processing apparatus;
identifying a first command to be executed by the first task, the first command being associated with commands to be executed as a group;
in response to identifying the first command, suspending the task by freezing a call stack associated with the first task;
associating the task with a set of previously suspended tasks based on the first command; and
while the first task is suspended processing a second task on the data processing apparatus.

14. The medium of claim 13, wherein identifying the first command includes comparing an operator of the first command to a predefined list of operators.

15. The medium of claim 13, wherein the operations further comprise:
in response to determining a condition has occurred, continue executing each of the tasks in the set of previously suspended tasks.

16. The medium of claim 15, wherein the determining that the condition has occurred includes comparing a count of the tasks in the set of previously suspended tasks to a threshold value.

17. The medium of claim 15, wherein determining that the condition has occurred is based on a time associated with at least one task in the set of previously suspended tasks and the current time.

18. The medium of claim 17, wherein freezing the call stack includes moving the call stack from a first memory to a second memory.
